(19) United States
(12) Patent Application Publication
(10) Pub. No.: US 2026/0260173 A1
(43) Pub. Date: Sep. 3, 2026

(54) MODEL-DRIVEN CONSTRAINT-BASED TRANSFORMATION, CONTROL, AND EVALUATION OF COMPUTATIONAL SYSTEMS

(71) Applicant: Alistair de Blacquiere-Clarkson, Sydney (AU)

(72) Inventor: Alistair de Blacquiere-Clarkson, Sydney (AU)

(21) Appl. No.: 19/664,516

(22) Filed: Apr. 30, 2026

(51) Int. Cl. G06N 20/00

(52) U.S. Cl. CPC G06N 20/00

(57) ABSTRACT

A computer-implemented system and method for controlling, testing and specifying behaviour of a computational system, including machine learning models, based on a structured model are disclosed. The structured model includes components, relationships, and configuration parameters. One or more requirements are obtained from the structured model or external sources, and constraints are generated based on the requirements and an execution context. The constraints are represented as structured constraint objects and may be included in a machine-readable contract. One or more prompts or documents are generated based on the structured constraint representation to control, test or specify behavior of a computational system, including, but not limited to, a machine learning model. Outputs generated by the computational system may be evaluated against the structured constraint representation using deterministic evaluation rules, and prompts or inputs may be modified to regenerate outputs until the outputs correspond to the constraints.

### FIELD OF THE INVENTION

The present disclosure relates to computer-implemented systems for transforming structured models into machine-consumable representations used to control, test and specify behavior of computational systems, including, but not limited to, machine learning systems, through model-driven prompt generation, constraint enforcement, and deterministic evaluation of outputs.

### BACKGROUND

Structured models such as diagrams, configuration files, and architectural representations are widely used to describe systems across software, infrastructure, and business domains. However, such models are not directly executable.

Machine learning (ML) systems, including large language models (LLMs), can generate outputs such as code, configurations, and analyses, but lack mechanisms for reliably incorporating structured system definitions and constraints.

Accordingly, there is a need for systems that transform structured models into executable prompts, optionally enforce constraints derived from requirements associated with the structured models, and that optionally orchestrate execution across multiple steps or agents.

### SUMMARY OF THE INVENTION

The present disclosure provides systems and methods for generating executable prompts from structured models. A structured model may include components, relationships, and configuration parameters.

Prompts are generated based on the structured model and may optionally incorporate specifications, controls, or constraints generated from requirements associated with the structured model, wherein the requirements are derived from diagram structure, configuration parameters, or external sources, and further based on an execution context. The prompts are executable by a computational system, including, but not limited to, a machine learning system, to generate outputs.

In some embodiments, outputs are evaluated and prompts are modified or re-executed to enforce constraints. In some embodiments, execution is coordinated across multiple prompts using an orchestration engine.

In some embodiments, domain-specific requirements, including cybersecurity requirements, are derived from the structured model and represented as constraint objects. Requirements may be derived based on component types, relationships, or configuration semantics.

### BRIEF DESCRIPTION OF DRAWINGS

The accompanying drawings are incorporated herein and form part of the specification and illustrate example embodiments of the disclosed system and methods. Each drawing includes the figure number at the bottom.

FIG. 1 illustrates an example system architecture including a structured model, a requirements derivation module, a constraint generation module, a structured constraint representation, a prompt/artifact generation engine, a computational system including a machine learning model, an evaluation and enforcement module, an orchestration engine, deterministic outputs, and machine learning-generated outputs. The figure illustrates transformation of a structured model into requirements and constraints, generation of a structured constraint representation, and generation of outputs including deterministic outputs and machine learning-generated outputs. The machine learning-generated outputs are generated downstream of the prompt/artifact generation engine and are optional.

FIG. 2 illustrates an example transformation process in which configuration parameters of a structured model are first converted into requirement representations. The requirements are then transformed into constraint objects based on an execution context, including characteristics of the computational system, such as a machine learning model, or target environment. The resulting constraint representation is used to generate one or more prompts.

FIG. 3 illustrates an example orchestration architecture in which multiple prompts are generated from a structured model and executed according to dependencies, including assigning of prompts to agents and coordination of multi-step execution.

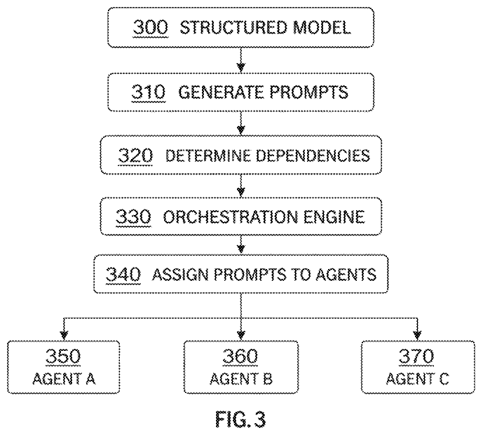

FIG. 4 illustrates an example interaction between agents and tool interfaces, including invocation of external processes and generation of outputs based on such interactions.

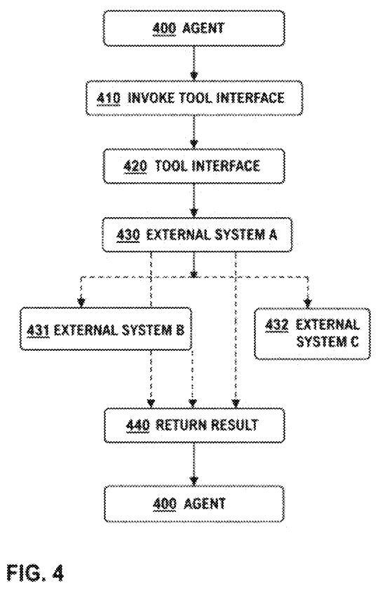

### DETAILED DESCRIPTION

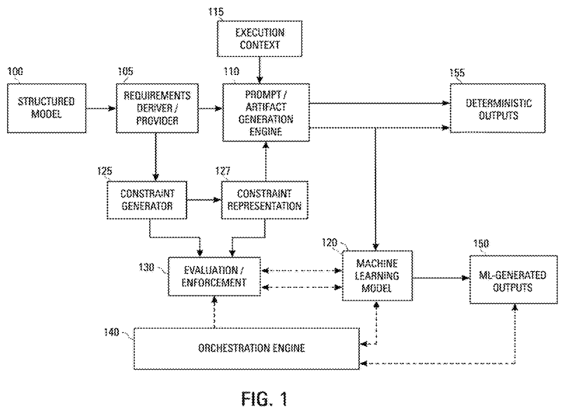

Referring to FIG. 1, a system architecture is illustrated for transforming structured models into machine-consumable representations via constraint-driven generation. The system includes a structured model 100, a requirements derivation module 105 configured to derive or obtain one or more requirements associated with the structured model, a constraint generation module 125 configured to generate one or more constraints based on the requirements and an execution context, and a structured constraint representation 127 generated from the constraints. The system further includes a prompt/artifact generation engine 110 configured to generate one or more prompts or artifacts based on the structured constraint representation. The system includes a computational system, including, but not limited to, a machine learning model 120, configured to process prompts to generate machine learning-generated outputs 150. The prompt/artifact generation engine 110 or the structured constraint representation 127 may generate deterministic outputs 155, including structured artifacts, independently of the machine learning model 120. The system further includes an evaluation and enforcement module 130 configured to evaluate outputs generated by the computational system against the structured constraint representation and to influence subsequent processing. An orchestration engine 140 may coordinate execution of multiple steps or components. In some embodiments, an execution context 115 provides contextual information used in generating constraints. In some embodiments, one or more modules may be omitted, combined, or implemented as part of other modules.

### Structured Model (100)

In various embodiments, the system includes or is configured to access a structured model 100. The structured model 100 comprises a plurality of components, relationships among the components, and configuration parameters associated with at least one component. The structured model 100 may be represented as a graph structure, a hierarchical schema, or a structured data format, including, but not limited to, JSON or XML.

In some embodiments, configuration parameters of the structured model are associated with domain-specific requirements, including, but not limited to, cybersecurity requirements such as authentication, authorization, encryption, or policies derived from compliance frameworks. Such requirements may be used to generate or derive constraint objects that are configured to control or validate outputs generated by a computational system, including, but not limited to, a machine learning model.

A “requirement” refers to an abstract or domain-level condition, objective, policy, or specification defining one or more controls to be applied in a structured model, independent of a specific execution context, and may be derived from the structured model or obtained from an external source. In some embodiments, requirements are derived from one or more policy definitions, rule sets, or configuration schemas. A policy definition may include a structured or semi-structured representation, including formats such as YAML, JSON, or other declarative formats, specifying one or more rules, controls, or conditions. Requirements may correspond directly to individual policy elements or may be derived by extracting, normalizing, or interpreting policy-defined rules. Accordingly, a policy definition may serve as a source of requirements, and requirements may represent a normalized or abstracted representation of one or more policy-defined rules.

In some embodiments, the system includes a requirements derivation module 105 configured to derive or obtain one or more requirements associated with the structured model 100. The requirements derivation module 105 may process configuration parameters of the structured model, external inputs, policy definitions, or user-provided data to generate requirements.

In some embodiments, the requirements derived or obtained by the requirements derivation module 105 are provided to the constraint generation module 125, which generates one or more constraints based on the requirements and an execution context. The constraints may be generated by selecting, mapping, or transforming the requirements into context-dependent representations suitable for controlling, guiding, or validating outputs of a computational system.

In some embodiments, a constraint generation module 125 is configured to generate one or more constraints based on the requirements and the execution context. The constraint generation module 125 may select, map, or transform requirements into context-dependent constraints.

In some embodiments, the system generates a structured constraint representation 127 based on the generated constraints. The structured constraint representation may comprise a plurality of constraint objects and may be used by the prompt generation engine 110 to generate prompts or documents.

A “constraint” refers to a context-dependent representation of a requirement or a control derived therefrom, expressed in a form suitable for controlling, guiding, or validating outputs of a computational system, including, but not limited to, a machine learning model. Constraints are distinct from threat definitions or attack representations and are not derived from threat models.

A “specification” is a document or structured representation of one or more requirements or constraints derived from a structured model, which may be used to generate one or more prompts or documents for a computational system, including, but not limited to, a machine learning model. In some embodiments, the one or more documents generated based on the structured constraint representation comprise structured or semi-structured artifacts including, but not limited to, configuration files, executable specifications, code artifacts, workflow definitions, policy documents, or machine-consumable representations. Such documents may be formatted in declarative or programmatic formats, including JSON, YAML, source code, or domain-specific languages, and are configured to control, guide, test, or specify behavior of a computational system.

In some embodiments, the specification includes, and in some embodiments generates, a machine-readable contract comprising a structured representation of one or more requirements or constraints derived from the structured model or an external source. In some embodiments, the constraints are generated based on one or more controls or requirements associated with the structured model and an execution context, such that the contract represents at least a portion of the constraints corresponding to the controls. The contract may be used to generate one or more prompts or documents, or to guide, constrain, or validate outputs of a computational system, including, but not limited to, a machine learning model.

In some embodiments, the machine-readable contract comprises at least a portion of a structured constraint representation generated through a transformation process in which one or more requirements associated with the structured model are used to generate context-dependent constraints based on an execution context.

In some embodiments, the contract or specification may be provided to a computational system, including, but not limited to, a machine learning model, as structured input or via one or more transformation layers.

In some embodiments, the system generates a specification comprising a structured representation of one or more requirements or constraints derived from the structured model. The specification may include a list of constraint objects, configuration parameters, or rules associated with one or more components. The specification may be used to generate one or more prompts or documents for the computational system, including, but not limited to, a machine learning model.

In some embodiments, a single requirement may correspond to multiple constraints depending on an execution context, capabilities of the computational system or model, or transformation rules.

In some embodiments, requirements specify one or more controls for application, and constraints are generated based on the controls and an execution context.

In some embodiments, constraints may include required attributes of outputs, prohibited characteristics, operational rules, and validation conditions.

In some embodiments, constraints are not statically derived from configuration parameters, but are dynamically generated from requirements based on an execution context that includes characteristics of the computational system, target environment, or orchestration state.

Accordingly, identical requirements may result in different constraint representations in different contexts.

In some embodiments, requirements are derived from configuration parameters of the structured model. In other embodiments, requirements are received from external sources, policy definitions, user inputs, or domain-specific frameworks. Accordingly, requirements need not be derived from the structured model and may be provided independently thereof.

In some embodiments, relationships define dependencies between components, including directional dependencies, data flows, or execution constraints.

### Prompt Generation Engine (110)

The prompt generation engine 110 is configured to transform the structured model 100 into one or more executable prompts. This transformation includes:
(1) extracting configuration parameters from the structured model;
(2) converting the configuration parameters into one or more requirements or receiving requirements from an external source;
(3) generating one or more constraints based on the requirements and an execution context, using the constraint generation module 125;
(4) generating a structured constraint representation; and
(5) embedding the structured constraint representation into one or more structured prompts or documents.
   In some embodiments, the prompt generation engine generates one or more documents in addition to or instead of prompts, wherein the documents comprise structured artifacts configured to control or specify behavior of a computational system.

In some embodiments, the computational system may comprise a machine learning model, such as a large language model, configured to generate text, code, or structured outputs.

The transformation may be implemented using rule-based mapping, schema-driven compilation, or graph traversal techniques. The prompt generation engine 110 may generate prompts corresponding to individual components, groups of components, or execution stages.

In some embodiments, prompts may be generated directly from configuration parameters without explicitly materializing a structured constraint representation, while still utilizing constraints derived from requirements.

### Example Transformation

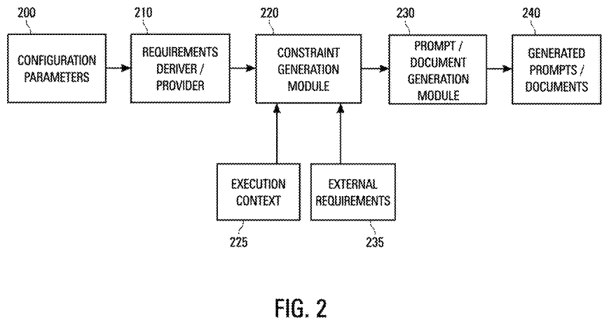

Referring to FIG. 2, an example transformation of a structured model into a constraint representation and corresponding prompt is described.

### Structured Model (Example YAML):

```
components:
  api_service:
    type: service
    prompts:
      “create a %NAME with the following constraints
%CONSTRAINTS and %GENERATION_RULES”
      “execute tool %ENABLED_TOOL with payload
%CONSTRAINTS”
    language: python
```

### A Policy (Example YAML):

```
policy:
  applies_to: api_service
  requirements:
    encryption_in_transit: true
    authentication: true
    api_type: REST
```

### Derived Constraint Representation (Example JSON):

```
{
  “component”: “api_service”,
  “type”: “service”,
  “constraints”: [
    {
      “type”: “output_format”,
      “value”: “REST”,
      “enforcement”: “specified”
    },
    {
      “type”: “authentication”,
      “value”: true,
      “enforcement”: “specified”
    },
    {
        “type”: “encryption_in_transit”,
      “value”: “TLS 1.3”,
        “constraint”: “derived from policy and
component type, the api service is expected to implement
encryption in transit”
      },
    {
        “type”: “ingress”,
      “value”: “api only access from non-browser
clients”,
        “constraint”: “derived based on properties
of the structured model, including component types and
relationships. Considering that the component type is a REST API
service and relationship is that it is connected only to other
REST API services, the component is constrained to accept API
connections from non-browser clients”
      },
    ],
    “generation_rules”: {
      “language”: “python”,
      “include_security_layer”: true
    }}
```

In some embodiments, the structured constraint representation comprises an intermediate representation used by the prompt generation engine to generate one or more prompts. Configuration parameters are normalized into discrete constraint objects, and additional generation rules may be derived based on properties of the structured model, including component types and relationships.

### Generated Prompt (Example):

Generate an api_service with the following constraints:
output_format: REST
authentication: specified
language: Python
security_layer: enabled
encryption_in_transit: “TLS 1.3 Only”
ingress: “api only access from non-browser clients”
   Ensure generated outputs correspond to the structured constraint representation.

In this example, the structured model and policy define one or more requirements, and the constraint objects include both constraints generated directly from the requirements and constraints derived based on inferred properties of the structured model and execution context.

In some embodiments, the structured constraint representation provides an abstraction layer that decouples requirements from system-specific implementations, enabling consistent control and evaluation across different computational systems and execution contexts.

The foregoing example is illustrative, and the structured model and constraint representation may be implemented using other data formats and representations.

### Machine Learning Model (120)

In some embodiments, the computational system may comprise a machine learning model 120 configured to process the generated prompts and produce outputs.

Outputs may include code artifacts, configuration files, workflow definitions, or agents configured to perform tasks.

In some embodiments, outputs correspond to components defined in the structured model 100, thereby instantiating elements of the structured model in executable form.

### Evaluation and Enforcement Module (130)

The evaluation and enforcement module 130 is configured to evaluate outputs generated by the computational system, including, but not limited to, the machine learning model 120 against the structured constraint representation derived from the structured model 100.

Evaluation may include rule validation, structural comparison, and determination of conformance with the structured constraint representation.

If outputs do not correspond to the structured constraint representation, the module 130 may modify prompts, introduce corrective constraints, or trigger regeneration of outputs. This process may be iterative until outputs correspond to the structured constraint representation. In some embodiments, outputs generated by the computational system are not required to be identical across executions, but are constrained to conform to the structured constraint representation, such that conformance is deterministically verifiable.

In some embodiments, evaluation and enforcement of constraints may be optional. In such embodiments, prompts may be executed without validation against the constraint representation, or evaluation may be performed by an external system independent of the prompt generation engine.

In some embodiments, conformance with the structured constraint representation may correspond to conditions associated with external frameworks or policies. However, the system does not determine compliance, certification, or adherence to any predefined standard, and conformance is evaluated independently of any compliance determination.

In some embodiments, the system generates an expected observation specification corresponding to the one or more constraints, the expected observation specification comprising a structured representation of one or more expected states, evaluation conditions, or observable characteristics associated with the constraints. The expected observation specification may define, for each component or constraint, an expected configuration state or alignment condition without requiring observation of a deployed system.

In some embodiments, the expected observation specification is generated independently of runtime system data and may be used to guide evaluation, validation, or testing of outputs or configurations corresponding to the structured model.

### Orchestration Engine (140)

The orchestration engine 140 is configured to coordinate execution of multiple prompts based on dependencies derived from relationships within the structured model 100.

The orchestration engine 140 may determine execution order based on dependency graphs, execute prompts sequentially, in parallel, or in hybrid configurations, and route outputs from one prompt as inputs to another.

In some embodiments, the system generates agents assigned to prompts. The orchestration engine 140 manages agent execution and interaction.

In some embodiments, orchestration of prompt execution may be optional. Prompts may be executed independently without dependency-based coordination, or execution may be managed externally without the orchestration engine described herein.

### Tool Interface Integration

In some embodiments, the structured model 100 defines tool interfaces. Prompts may include instructions to invoke external systems via application programming interfaces (APIs) or workflows.

### Deterministic Vulnerability Coverage Evaluation

In some embodiments, the system further comprises a correspondence evaluation module configured to determine correspondence between a set of enabled controls derived from components of the structured model and a reference set of controls associated with a vulnerability definition. A vulnerability definition may include an identifier corresponding to a known weakness, such as a Common Weakness Enumeration (CWE) or Common Vulnerabilities and Exposures (CVE) identifier, and a reference set of controls associated with the vulnerability. In some embodiments, the vulnerability definition is provided as input and is not required to be retrieved from a predefined vulnerability library or threat database. In some embodiments, the system does not perform threat enumeration, threat model generation, or attack path analysis, and does not derive threats from the structured model. The vulnerability definition may be provided as input to the system via an interface or data source.

In some embodiments, the vulnerability definition provides a reference set of controls for comparison and does not determine required controls, and the system does not infer mitigation, effectiveness, or sufficiency of controls from the vulnerability definition.

In some embodiments, for each component of the structured model, the system determines a set of enabled controls based on constraints generated from requirements associated with the structured model and an execution context. The enabled controls correspond to controls represented within a structured constraint representation derived through a transformation process from the structured model. In some embodiments, the enabled controls are derived from constraint representations generated from the structured model and are not directly specified by user input or vulnerability definitions. The enabled controls are derived independently of the vulnerability definition and are not selected, filtered, or determined based on the vulnerability definition.

In some embodiments, the system operates on a model-defined representation of a system and does not rely on network-discovered data including Internet Protocol addresses, device inventories, software inventories, or runtime system state information.

In some embodiments, the system evaluates correspondence between the enabled controls and a reference set of controls associated with a vulnerability definition by comparing the enabled controls with the reference set of controls to determine an alignment status for each component. The enabled controls are derived from constraints generated from the structured model and one or more policy definitions, and are independent of vulnerability metrics. In some embodiments, vulnerability metrics are used to organise, group, or present controls within a visual representation, without determining or selecting the enabled controls or the reference set of controls. The system determines correspondence between the sets without deriving controls from vulnerability metrics or determining controls based on identified threats.

In some embodiments, the correspondence result is computed using deterministic rules, including determining a set of corresponding controls representing an intersection between the enabled controls and the reference set of controls, and determining a set of non-corresponding controls representing elements of the reference set of controls that are not present in the enabled control set.

In some embodiments, each component is associated with an alignment status based on the correspondence between the enabled controls and the reference set of controls, wherein the alignment status indicates a degree of correspondence between the sets without representing mitigation, effectiveness, or sufficiency of the enabled controls with respect to the vulnerability definition.

In some embodiments, the correspondence evaluation is performed deterministically such that identical structured models, requirements, constraints, execution contexts, and vulnerability definitions produce identical correspondence results. The correspondence evaluation is performed independently of probabilistic scoring, heuristic threat modeling, or attack path analysis, and without probabilistic inference or adversarial simulation.

In some embodiments, the correspondence evaluation is integrated with the transformation and enforcement pipeline described herein, such that the enabled controls are derived from constraint representations generated from the structured model and are not derived from threat models or vulnerability-based control selection.

In some embodiments, the system generates an output representation including the correspondence results for a plurality of components, the output representation including, for each component, the alignment status, corresponding controls, and non-corresponding controls, and being provided via a user interface or an application programming interface. In some embodiments, correspondence results are not persisted as properties of the structured model and are maintained separately from the model representation.

In some embodiments, the correspondence evaluation is based on the structured constraint representation and/or a machine-readable contract comprising a structured representation of one or more requirements or constraints, such that the contract is used to determine the enabled controls for each component.

In some embodiments, the vulnerability definition includes a standardized vector string comprising metric-value pairs. The system parses the vector string, validates the metric-value pairs, rejects invalid metric-value pairs, and applies deterministic default values for missing metrics. The parsed vector and a normalized vector representation may be stored with an assessment record and used to define evaluation scope or select reference controls without deriving threats or attack paths. The standardized vector string defines contextual characteristics for evaluation scope and does not determine required controls or mitigation logic.

In some embodiments, determining the set of enabled controls comprises resolving an effective control value for each control based on one or more of explicit component configuration, inherited values, default values, derived values, rule outputs, policy outputs, or evaluation outputs. In some embodiments, derived values from rules or policies override base defaults according to a deterministic precedence order.

In some embodiments, correspondence results are computed for entities of the structured model, including component entities and connection entities. For each entity, the system computes corresponding controls, non-corresponding controls, and unconfigured controls, and assigns an alignment status based on the computed sets.

In some embodiments, correspondence results are grouped into categories based on configuration group keys associated with controls. Category display order may follow a section order defined by the structured model, and categories may be displayed even when containing zero counts. Control keys may be deterministically mapped to category groups prior to generating correspondence summaries.

In some embodiments, the system stores assessment inputs including at least one of a vulnerability definition, normalized vector, ruleset version, model version identifier or hash, and timestamp. The system may reproduce a prior correspondence evaluation from the stored inputs and may indicate when a ruleset version or model version differs from a version used for a prior evaluation.

In some embodiments, the output representation further comprises a visual representation of the structured model in which correspondence results are associated with corresponding components of the structured model. Each component may be annotated with one or more indicators representing the alignment status.

In some embodiments, the visual representation is generated by mapping the correspondence results to graphical elements corresponding to the components of the structured model, such that the alignment status is displayed in context of the relationships and structure of the model.

In some embodiments, the visual representation includes visual indicators corresponding to the alignment status, including color coding, symbols, or numerical indicators representing corresponding controls and non-corresponding controls for each component.

In some embodiments, the visual representation is interactive, enabling selection of a component to access associated correspondence results, including corresponding controls, non-corresponding controls, and constraint information derived from the structured model.

### Variations

The embodiments described herein are illustrative and non-limiting. Modifications may be made without departing from the scope of the claims.

### Technical Effect

The disclosed system improves reliability and determinism of outputs generated by a computational system, including machine learning outputs, by converting structured configuration parameters into requirements, and generating enforceable constraints based on the requirements and an execution context, embedding constraints into prompts, iteratively enforcing conformance with constraints, and coordinating multi-step execution based on model-derived dependencies.

These features enable structured models to be transformed into executable systems with improved accuracy and reduced error propagation.

1. A computer-implemented method comprising: receiving a structured model comprising components, relationships, and configuration parameters; deriving or obtaining one or more requirements associated with the structured model, wherein the requirements include at least one of requirements derived from the configuration parameters or received from an external source; generating one or more constraints by selecting, mapping, or transforming the requirements based on an execution context, wherein the constraints define required characteristics, prohibited characteristics, or operational conditions, or control parameters that influence system behaviour, configuration, or generated outputs; generating a structured constraint representation based on the constraints; and generating, based on the structured constraint representation, one or more prompts or documents configured to control, test, or specify behavior of a computational system, including, but not limited to, a machine learning model.

2. The method of claim 1, wherein generating the constraints, structured constraint representation, and prompts is performed deterministically such that identical inputs produce outputs that deterministically conform to the structured constraint representation.

3. The method of claim 1, wherein the requirements comprise one or more rules, policies, or configuration conditions associated with the structured model, and wherein the constraints comprise context-dependent representations of the requirements including control parameters that influence system behaviour, configuration, or generated outputs.

4. The method of claim 1, wherein generating the prompts comprises embedding a structured representation of the constraints into the prompts, and wherein the prompts are configured to invoke a tool interface associated with the structured model to interact with an external system.

5. The method of claim 1, further comprising providing the one or more prompts to the computational system, including, but not limited to, a machine learning model to generate one or more outputs, evaluating the outputs against the structured constraint representation, and modifying at least one prompt or input to regenerate outputs until the outputs correspond to the structured constraint representation.

6. The method of claim 1, further comprising generating an expected observation specification comprising a structured representation of one or more expected states, evaluation conditions, or observable characteristics associated with the one or more constraints.

7. The method of claim 1, further comprising generating one or more deterministic outputs based on the structured constraint representation, wherein the deterministic outputs comprise structured artifacts generated independently of a machine learning model.

8. The method of claim 1, further comprising generating a machine-readable contract representing at least a portion of the requirements or constraints, wherein the machine-readable contract is reusable across multiple execution contexts or machine learning models.

9. The method of claim 8, wherein the machine-readable contract is provided directly as structured input to the machine learning model.

10. The method of claim 1, wherein at least one constraint is derived based on inferred properties of the structured model including component types or relationships.

11. The method of claim 1, further comprising generating a plurality of prompts and executing the prompts according to dependencies derived from the structured model, wherein execution is performed sequentially, in parallel, or in a hybrid configuration.

12. The method of claim 1, wherein generating the one or more constraints comprises dynamically generating multiple context-dependent constraints from a single requirement based on at least one of execution context, model characteristics, or transformation rules, such that identical requirements produce different constraint representations under different contexts.

13. A non-transitory computer-readable medium storing instructions that, when executed, cause a processor to perform the method of claim 1.

14. A computer-implemented system comprising: a model input module configured to receive a structured model; a requirement module configured to obtain one or more requirements associated with the structured model; a constraint generation module configured to generate one or more constraints by selecting, mapping, or transforming the requirements based on an execution context, wherein the constraints define required characteristics, prohibited characteristics, operational conditions, or control parameters that influence system behaviour, configuration, or generated outputs; and a prompt generation module configured to generate one or more prompts or documents based on a structured constraint representation, the prompts or documents configured to control, test, or specify behavior of a computational system, including, but not limited to, a machine learning model.

15. The system of claim 14, further comprising an evaluation module configured to evaluate outputs generated by the computational system, including, but not limited to, a machine learning model against the structured constraint representation.

16. The system of claim 14, further comprising an orchestration module configured to execute a plurality of prompts based on dependencies derived from relationships in the structured model.

17. The system of claim 14, wherein the constraint generation module is configured to generate different constraints for a same requirement based on different execution contexts.

18. The method of claim 1, further comprising: receiving a vulnerability definition including a reference set of controls; determining, for at least one component of the structured model, a set of enabled controls derived from constraints represented in the structured constraint representation; and computing a correspondence result based on a comparison between the set of enabled controls and the reference set of controls, the correspondence result including at least one of a set of corresponding controls representing an intersection between the sets or a set of non-corresponding controls representing elements of the reference set not present in the enabled controls.

19. The method of claim 18, wherein the correspondence result further comprises assigning an alignment status based on the corresponding controls and non-corresponding controls, the alignment status indicating a degree of correspondence between the sets.

20. The method of claim 18, wherein the correspondence result is determined deterministically such that identical structured models, requirements, constraints, execution contexts, and vulnerability definitions produce identical correspondence results.
